(19) United States
(12) Patent Application Publication
(10) Pub. No.: US 2020/0399008 A1
(43) Pub. Date: Dec. 24, 2020

(54) LABEL SUPPLY APPARATUS AND LABEL RECOVERY APPARATUS

(71) Applicant: TOSHIBA TEC KABUSHIKI KAISHA, Tokyo (JP)

(72) Inventors: Takashi OHISA, Numazu Shizuoka (JP); Koichi HIRUTA, Mishima Shizuoka (JP)

(21) Appl. No.: 16/800,540

(22) Filed: Feb. 25, 2020

(30) Foreign Application Priority Data
Jun. 18, 2019 (JP) 2019-112928

(51) Int. Cl. B65C 9/18; B65C 9/40; B65C 9/28

(52) U.S. Cl. CPC B65C 9/1884; B65C 9/1826; B65C 2009/404; B65C 9/28; B65C 9/40

(57) ABSTRACT

A label supply apparatus includes a suction portion having a suction surface on which a label with an adhesive is to be held, sensors on the suction surface, and a controller configured to determine whether the label is held on the suction surface at a proper position or an improper position based on sensing results from the sensors.

### CROSS-REFERENCE TO RELATED APPLICATIONS

This application is based upon and claims the benefit of priority from Japanese Patent Application No. 2019-112928, filed on Jun. 18, 2019, the entire contents of which are incorporated herein by reference.

### FIELD

Embodiments of the present invention relate to a label supply apparatus and a label recovery apparatus.

### BACKGROUND

Conventionally, in the field relating to distribution, production, and sale of objects, label supply apparatuses and the like are used to attach labels such as labels, price tags and the like to the objects. An example of such a label supply apparatus includes an apparatus in which a label is peeled from a base paper to which the label is adhered, and the label is then attached to the object.

In the label supply apparatus described above, when the a position of the label attached to the object deviates from a target position by a predetermined range, the label is determined as defective, the operator of the label supply apparatus stops the label supply apparatus, and performs work for removing the defective label.

However, in the above-described configuration, the operator is required to respond each time a defective label is generated, which is inefficient. Since the recovered defect label is discarded, it is also inefficient from a cost point of view.

### BRIEF DESCRIPTION OF THE DRAWINGS

FIG. 1 is a diagram illustrating an example of a configuration of a label supply apparatus according to an embodiment.

FIG. 2 is a diagram schematically showing the suction surface of the suction portion according to the embodiment.

FIG. 3 is a diagram schematically showing a cross section of an arm and a suction portion according to an embodiment of the present invention.

FIGS. 4A, 4B, and 4C illustrate the relationship between a second sensor installed on the suction surface of the embodiment and the suction position of the label.

FIG. 5 is a block diagram illustrating an example of a hardware configuration of a label supply apparatus according to an embodiment.

FIG. 6 is a block diagram illustrating an example of a functional configuration of a label supply apparatus according to an embodiment.

FIGS. 7A, 7B, and 7C illustrate the recovery operation and the position adjustment operation of the defective label performed by the position adjuster of the embodiment.

FIG. 8 is a flowchart illustrating an example of a label application process performed by the label supply apparatus according to the embodiment.

### DETAILED DESCRIPTION

A label supply apparatus includes a suction portion having a suction surface on which a label with an adhesive is to be held, sensors on the suction surface, and a controller configured to determine whether the label is held on the suction surface at a proper position or an improper position based on sensing results from the sensors.

Embodiments of the label supply apparatus and the recovery apparatus will now be described in detail with reference to the accompanying drawings. The present invention is not limited to the embodiments described below.

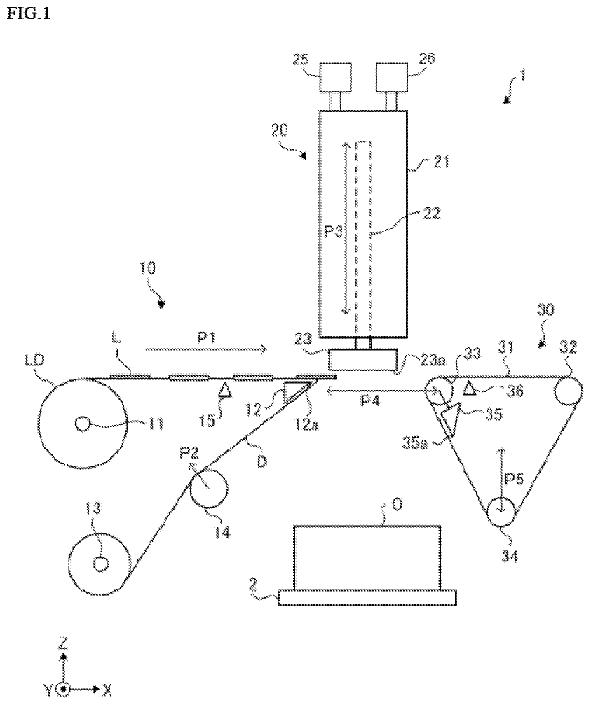

FIG. 1 is a diagram illustrating an example of a configuration of a label supply apparatus according to an embodiment. As shown in FIG. 1, the label supply apparatus 1 includes a label supply mechanism 10, a label attaching mechanism 20, and a collection mechanism 30.

The label supply mechanism 10 is provided with a mechanism for supplying a label L having an adhesive on one surface thereof, to the label attaching mechanism 20. Specifically, the label supply mechanism 10 includes a supply axis 11, a first peeling portion 12, a sheet winding shaft 13, a tension roller 14, and a first sensor 15 as a mechanism portion.

The supply shaft 11 rotatably supports a roll-shaped label sheet LD. The label sheet LD is composed of a long base sheet D to which labels L are attached at a predetermined interval. The label L is a seal sheet or the like having an adhesive on one surface (e.g., back surface) thereof, that is in contact with the base sheet D. It is assumed that a character string such as a slip number or a product name is printed in advance on the other surface (e.g., front surface) of the label L.

The label sheet LD supplied from the supply shaft 11 is conveyed in the direction of arrow P1 to reach the first peeling portion 12. The first peeling portion 12 has a tip portion 12a forming an acute angle, and the label L is peeled off from the label sheet LD by bending the label sheet LD around the tip portion 12a at an acute angle during conveyance. The label L peeled from the label sheet LD is supplied from the position of the first peeling portion 12 to the label attaching mechanism 20.

The sheet winding shaft 13 is driven to rotate by a winding driver 16 (see FIG. 5) to convey the label sheet LD in the direction indicated by the arrow P1. Further, the sheet winding shaft 13 winds the base sheet D from which the label L has been peeled off.

A tension roller 14 is provided between the first peeling portion 12 and the sheet winding shaft 13. The tension roller 14 is movable in the direction of arrow P2 to apply a predetermined tension to the base sheet D.

The first sensor 15 is, for example, a light transmissive or light reflective photosensor, and is provided on the upstream side of the first peeling portion 12. The first sensor 15 detects the label L conveyed in the direction of the arrow P1.

The label attaching mechanism 20 is provided with a mechanism for attaching the label L supplied from the label supply mechanism 10 to an object O. Specifically, the label attaching mechanism 20 includes a cylinder 21, an arm 22, and a label suction portion 23.

The cylinder 21 has a cylindrical shape, and a hollow interior. The arm 22 is provided inside the cylinder 21, and is configured to be movable in the vertical direction (in the direction indicated by arrow P3) within the cylinder 21 based on air pressure inside the cylinder 21. The arm 22 moves up and down in the cylinder 21 by pneumatic pressure. For example, an air compressor (referred to herein as an arm moving portion 25) is provided to generate positive pressure in the cylinder 21 to move the arm 22 down in the cylinder 21 and negative pressure in the cylinder 21 to move the arm 22 up in the cylinder 21.

The lower end of the arm 22 is provided with a label suction portion 23. The label suction portion 23 moves in the vertical direction along with the movement of the arm 22. The label suction portion 23 is positioned at a position corresponding to the height in the Z-axis direction of first peeling portion 12, that is, at a position (hereinafter referred to as a home position) where label L supplied from label supply mechanism 10 can be suctioned onto a suction surface 23a of the label suction portion 23, at the time when label L is to be attached to the object O.

The label suction portion 23 holds the label L supplied from the label supply mechanism 10 by negative pressure generated on the suction surface 23a by another air compressor (referred to herein as an air pressure generator 26). Further, when the separation distance between the suction portion 23 and the object O reaches a predetermined distance due to the lowering of the arm 22, the negative pressure is no longer applied or positive air pressure is generated on the suction surface 23a by air pressure generator 26, so that the label L detaches from the suction surface 23a and is able to be attached to the object O.

The object O is, for example, a box-shaped baggage or a commodity, and is conveyed in the Y direction in the figure by a conveying device 2 such as a conveyor belt. In the label supply apparatus 1 (in particular, the label attaching mechanism 20), the label L is attached in accordance with the timing at which the object O passes under the suction portion 23.

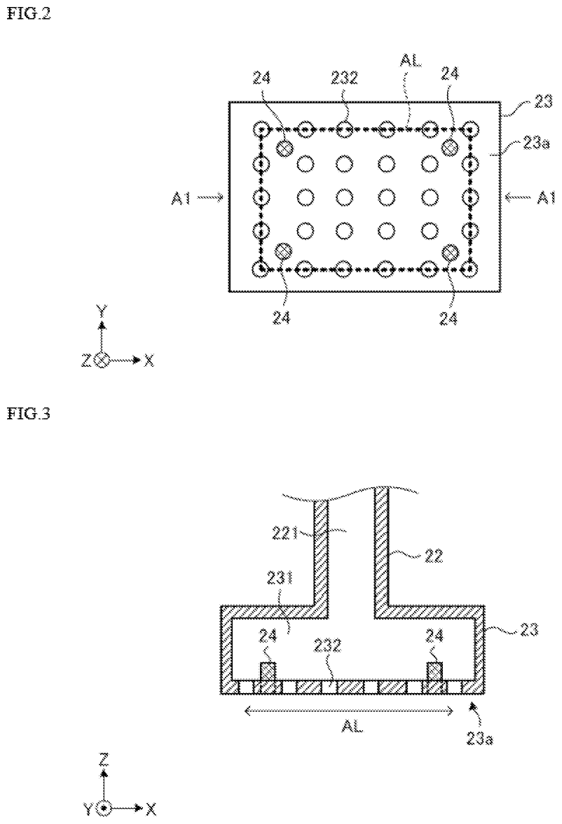

Referring to FIGS. 2 and 3, an example of a structure of suction portion 23 will be described. FIG. 2 is a diagram schematically showing suction surface 23a of suction portion 23. FIG. 3 is a diagram schematically showing a cross section of the arm 22 and the suction portion 23.

The suction portion 23 has a hollow portion 231 formed in a hollow shape. In addition, an air flow passage 221 connected to an air pressure generator 26, which will be described later, is formed in the arm 22 connected to the suction portion 23 so as to communicate with the hollow portion 231 of the suction portion 23.

The suction surface 23a of the suction portion 23 is formed, for example, in a rectangular shape, and has a size larger than that of the label L. Holes 232 communicating with the hollow portion 231 are provided over the entire surface of the suction surface 23a. The holes 232 are each formed to have a smaller size than the label L to prevent the label L from being sucked into the suction portion 23.

Further, a second sensor 24 is provided on the suction surface 23a. The second sensor 24 is an example of a first detection unit, and is realized by, for example, a light reflection type photosensor. One or a plurality of second sensors 24 are provided to detect the suction position of the label L at the suction surface 23a.

Although FIG. 2 shows an example in which four second sensors 24 are provided, it is assumed that the installation position and the number of second sensors 24 are not particularly limited. However, it is preferable that the second sensor 24 is disposed at a position where it can be determined whether or not the suction position of the label L is within the area AL indicating the range of the normal suction position of labels on the suction surface 23a. Here, the normal suction position means a suction position at the suction surface 23a, which allows the label L to be attached to a desired area on the object O when the label L is attached to the object O. FIG. 2 shows an example in which the second sensor 24 is provided on the peripheral edge of the area AL.

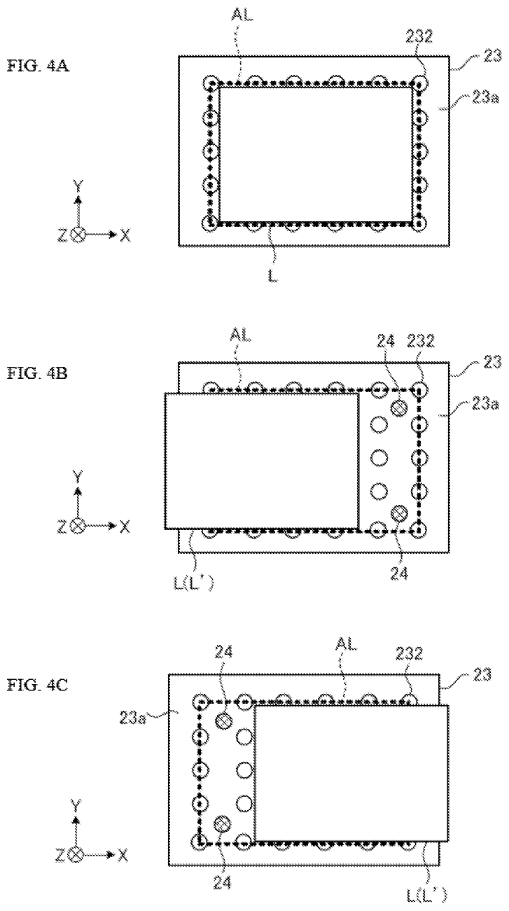

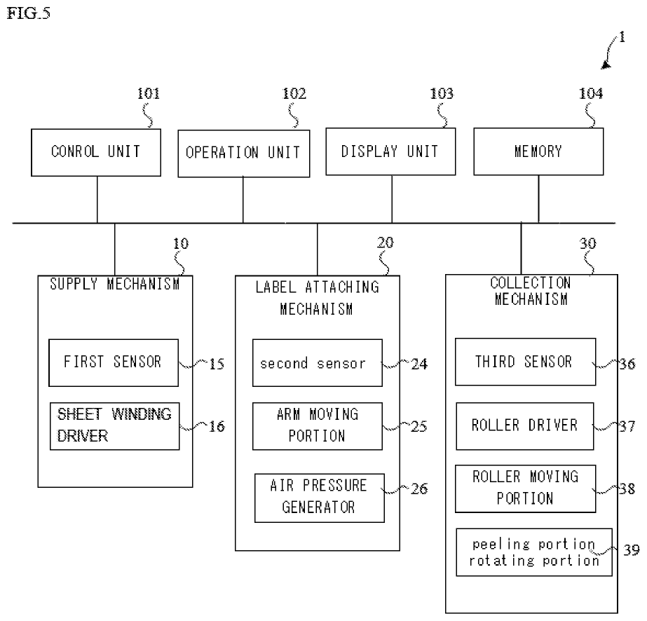

FIGS. 4A, 4B, and 4C illustrate the relationship between the second sensor 24 installed on the suction surface 23a and the suction position of the label L. FIGS. 4A, 4B, and 4C show a state in which the label L sucked and held on the suction portion 23 is viewed from below the suction surface 23a.

For example, as shown in FIG. 4A, when the label L is held at a position in the area AL, all of the second sensor 24 detects the presence of the label L. In this case, since the label L is held at the normal suction position, the label L can be attached to the intended position on the object O by lowering the arm 22 as it is.

On the other hand, as shown in FIGS. 4B and 4C, when the label L is held at a position deviated from the area AL, the presence of the label L is not detected by a part of the second sensor 24. In this case, since the label L is held at a suction position deviated from the normal suction position, when the arm 22 is lowered as it is, there is a possibility that the label L may be attached to an unintended position on the object O. In the following, the label L which is sucked and held at a position deviated from the area AL is also referred to as “defective label L′”.

Returning to FIG. 1, the collection mechanism 30 includes a mechanism for recovering the defective label L′ when the defective label L′ is detected by the label attaching mechanism 20, and for holding the defective label L′ again in the suction portion 23, as described above with reference to FIG. 1. Specifically, the collection mechanism includes a conveying belt 31, a driving roller 32, a movable roller 33, a tension roller 34, a second peeling portion 35, and a third sensor 36.

The conveying belt 31 is an endless conveying belt having both ends connected to each other, and is suspended around a movable roller 33, a driving roller 32, and a tension roller 34. The outer peripheral surface of the conveying belt 31 is subjected to processing for improving the releasability (i.e., reducing the amount of adhesion) of the outer peripheral surface of the conveying belt 31. The type of processing is not particularly limited, and various processing methods can be used. For example, in order to reduce the area of contact with the defective label L′, dimples or embossing may be applied to the surface of the conveying belt 31. Grooves may be formed on the surface of the conveying belt 31 along the conveying direction. Further, a hole smaller than the size of the label L may be provided on the entire surface of the conveying belt 31. In order to further improve releasability, Teflon® or fluororesin may be applied to the surfaces of conveying belt 31.

The driving roller 32 is driven to rotate by a roller driver 37 (refer to FIG. 5) to be described later, thereby driving the conveying belt 31. Specifically, when the driving roller 32 is driven to rotate, the conveying belt 31 rotates in accordance with the rotation of the driving roller 32. The rotation direction of the conveying belt 31 may be either a clockwise direction or a counterclockwise direction, or may be just a counterclockwise direction.

The movable roller 33 can be moved in the direction of arrow P4 under the control of a roller moving portion 38 (see FIG. 5) described later. As the movable roller 33 moves, the tension roller 34 moves in the direction of arrow P5, so that a predetermined tension is applied to the conveying belt 31 to prevent slack in the conveying belt 31. It is assumed that the height in the Z-axis direction of the driving roller 32 and the movable roller 33 is set substantially equal to that of the first peeling portion 12. It is assumed that the movable roller 33 is capable of moving below the suction portion 23 in the home position without coming into contact with the label supply mechanism 10 and the object O.

In the configuration described above, when the defective label L′ is detected in the label attaching mechanism 20, the collection mechanism 30 moves the movable roller 33 in the direction of the label attaching mechanism 20 and the suction portion 23 to extend the conveying belt 31 to be below the suction portion 23. Further, when the defective label L′ is recovered from the suction portion 23 by the conveying belt 31, the collection mechanism 30 moves the movable roller 33 in a direction away from the label attaching mechanism 20 and the suction portion 23, thereby retracting the conveying belt 31 from the position below the suction portion 31.

The second peeling portion 35 is provided integrally with the movable roller 33, and is capable of rotating about the center of rotation of the movable roller 33. The second peeling portion 35 has a tip portion 35a having an acute cross section, similar to the first peeling portion 12. The tip portion 35a of the second peeling portion 35 is retracted to a position where it does not contact the conveying belt 31, and the tip portion 35a of the second peeling portion 35a is rotated toward the suction portion 23 and held at that position when the collected defective label L′ is delivered to the suction portion 23.

The third sensor 36 is an example of a second detection unit, and is realized by, for example, a light reflection type or a light transmission type photosensor. The third sensor 36 is provided integrally with the movable roller 33 to detect a defective label L′ conveyed by the conveying belt 31.

Next, a description will be given of a configuration related to the control of the label supply apparatus 1 described above. FIG. 5 is a block diagram illustrating an example of a hardware configuration of the label supply apparatus 1.

As shown in FIG. 5, the label supply apparatus 1 includes a control unit 101. The control unit 101 includes a processor such as a CPU (Central Processing Unit) or the like, a ROM (Read Only Memory), a RAM (Random Access Memory), and the like.

The control unit 101 is connected to an operation unit 102, a display unit 103, a memory 104, and the like via a bus, an input/output controller, and the like.

The operation unit 102 is, e.g., an input device using which the label supply apparatus 1 can be operated. The display unit 103 is, e.g., a display device such as a liquid crystal display. The display unit 103 displays various kinds of information under the control of the control unit 101. The memory 104 includes a nonvolatile storage device such as a hard disk drive (HDD) or a flash memory. The memory 104 stores various programs executed by the control unit 101 and various setting information.

A label supply mechanism 10, a label attaching mechanism 20, and a collection mechanism 30 are connected to the control unit 101 via a bus, an input/output controller, and the like.

The label supply mechanism 10 includes, in addition to the first sensor 15 and the like described above, a winding driver 16 for rotationally driving the sheet winding shaft 13. The label attaching mechanism 20 includes, in addition to the second sensor 24 described above, an arm moving portion 25 for moving the arm 22 and the suction portion 23 in the vertical direction (the arrow P3 direction in FIG. 1), and an air pressure generator 26 for generating a negative pressure or a positive pressure in the hollow portion 231 of the suction portion 23 through the flow path 221 of the arm 22. The collection mechanism 30 includes, in addition to the third sensor 36 described above, a roller driver 37 for rotating the driving roller 32, a roller moving portion 38 for moving the movable roller 33 and the tension roller 34, and a peeling portion rotating portion 39 for rotating the second peeling portion 35.

The label supply mechanism 10, the label attaching mechanism 20, and the collection mechanism 30 perform various operations under the control of the control unit 101.

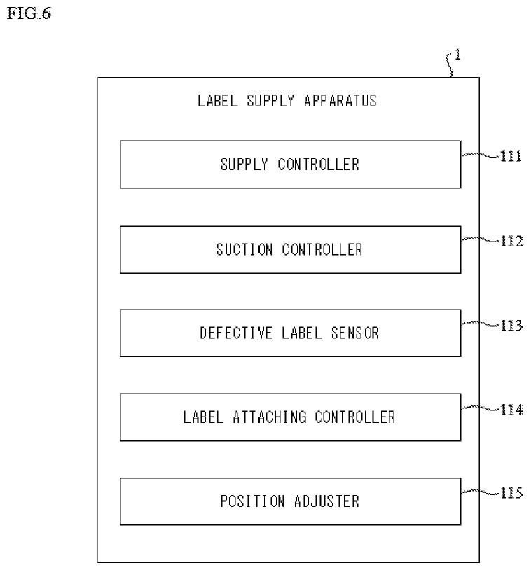

FIG. 6 is a block diagram illustrating an example of functional units of the label supply apparatus 1. As illustrated in FIG. 6, the label supply apparatus 1 includes a supply controller 111, a suction controller 112, a defective label sensor 113, a label attaching controller 114, and a position adjuster 115 as a functional configuration. The functional units may be realized by the processor of the control unit 101 executing the program of the memory 104. Further, these functional units may be realized in hardware by a dedicated processor such as an ASIC (Application Specific Integrated Circuit) included in the control unit 101.

The supply controller 111 controls the winding driver 16 to rotate the sheet winding shaft 13, thereby supplying the label L separated by the first peeling portion 12 to the label attaching mechanism 20. The supply controller 111 may control the supply timing of the label L in accordance with the label attaching operation of the label attaching mechanism 20 and the arrival timing of the object O conveyed by the transport device 2.

The suction controller 112 generates a negative pressure in the air pressure generator 26 in accordance with the supply timing of the label L, thereby causing the label L supplied from the label supply mechanism 10 to be suctioned to the suction surface 23a of the suction portion 23. Specifically, the suction controller 112 controls the timing at which the negative pressure is generated in the air pressure generator 26 based on the detection result of the first sensor 15. It is assumed that the height of the suction portion 23 at the time when the label L (and the defective label L′) is suctioned is located at the home position.

The defective label sensor 113 detects a label L (defective label L′) that deviates from an acceptable range of the area AL based on the detection result of the second sensor 24. Specifically, the defective label sensor 113 determines whether the suction position of the label L suctioned onto the suction surface 23a of suction portion 23 is within the area AL.

More specifically, when the label L is detected by all of the second sensors 24, the defective label sensor 113 determines that the defective label L′ is not detected and determines that the suction position is normal since the suction position of the label L is within the area AL. On the other hand, when the label L is not detected by all of the second sensors 24, the defective label sensor 113 determines that the defective label L′ has been detected since the label L is held at a position deviated from the area AL.

The label attaching controller 114 cooperates with the label attaching mechanism 20 in the following manner. When it is determined that a defective label is not detected by the defective label sensor 113, the label attaching controller 114 controls the arm moving portion 25 and the air pressure generator 26 to attach the label L held by the suction portion 23 to the object O. Specifically, the label attaching controller 114 controls the arm moving portion 25 to move the arm 22 downward until the separation distance between the suction surface 23a of suction portion 23 and the object O reaches a predetermined distance. Then, the label attaching controller 114 switches the air pressure of the air pressure generator 26 from the negative pressure to the positive pressure to discharge the label L, thereby allowing label L to be attached to the object O. When the attaching of the label L is completed, the label attaching controller 114 turns off the air pressure of the air pressure generator 26 and controls the arm moving portion 25 to return the suction portion 23 to the home position.

In this embodiment, the label L is ejected from the suction portion 23 by applying the positive pressure, but by turning off the negative pressure, the label L may fall freely onto the object O. In this case, although the height of the suction portion 23 at the time when the label L is attached is determined in advance according to the height of the object O, a sensor device for detecting the height of the object O may be separately provided, and the target height of the suction portion 23 may be determined based on the sensing result of the sensor device. For example, the suction portion 23 may be pressed directly against the object O to attach the label L to the object O.

On the other hand, when defective label L′ is detected by defective label sensor 113, position adjuster 115 suppresses the operation of supply controller 111 and label attaching controller 114, thereby stopping the application operation of label L (i.e., defective label L′) and the supply operation of new label L. Then, the position adjuster 115 controls the air pressure generator 26, the roller driver 37, the roller moving portion 38, the peeling portion rotating portion 39, and the like to cause the label supply apparatus 1 to execute the operation for adjusting the recovery and the suction position of the defective label L′. Here, the position adjuster 115 functions as an example of an adjustment unit by cooperating with each mechanism included in the label supply apparatus 1. In the case where the conveyance device 2 is controllable, the position adjuster 115 may temporarily stop the conveyance operation of the conveyance device 2 during the recovery of the defective label L′ and the adjustment of the suction position.

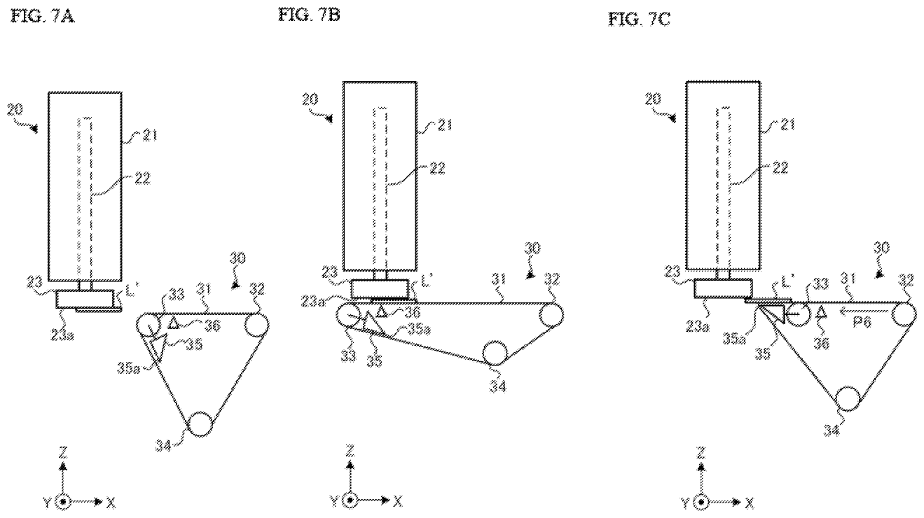

The operation example of the position adjuster 115 will be described below with reference to FIGS. 7A, 7B, and 7C. FIGS. 7A, 7B, and 7C illustrate the recovery operation and the position adjustment operation of the defective label L′ carried out by the position adjuster 115. In FIGS. 7A, 7B, and 7C, it is assumed that the suction portion 23 is located at the home position.

First, the position adjuster 115 stops the conveying belt 31 during the standby state in which the defective label L′ is not detected by the defective label sensor 113, and places the movable roller 33 at a position away from the suction portion 23 so as to bring the conveying belt 31 into the state shown in FIG. 7A. That is, the position adjuster 115 retracts the conveying belt 31 to a position that does not interfere with the label attaching operation of the label attaching mechanism 20 during the standby state.

In the state shown in FIG. 7A, when the defective label L′ is detected, the position adjuster 115 moves the movable roller 33 to a position below the suction portion 23, thereby causing the conveying belt 31 to extend below the suction portion 23 as shown in FIG. 7B. Thus, the conveying belt 31 is positioned below the suction portion 23.

Further, when the conveying belt 31 is brought to the state shown in FIG. 7B, the position adjuster 115 switches the air pressure of the air pressure generator 26 from the negative pressure to the positive pressure to eject the label L, thereby attaching the defective label L′ onto the conveying belt 31. Thus, the defective label L′ is recovered from the suction portion 23 onto the conveying belt 31. In this embodiment, the label L is ejected from the suction portion 23 by the application of the positive pressure, but by turning off the negative pressure, the label L may fall freely onto the conveying belt 31.

When the recovery of the label L is completed, the position adjuster 115 moves the movable roller 33 away from a position below the suction portion 23, thereby retracting the conveying belt 31 from the position below the suction portion 23 as shown in FIG. 7C. The position adjuster 115 then rotates the second peeling portion 35, so that the second peeling portion 35 is fixed at an angle that allows the conveying belt 31 passing over the second peeling portion 35 to be substantially parallel to the suction surface 23a of the suction portion 23.

When the second peeling portion 35 is rotated, the position adjuster 115 drives the driving roller 32 to convey the defective label L′ applied to the conveying belt 31 in the direction of the arrow P6. Thus, the defective label L′ is stripped from the conveying belt 31 at the location of the second peeling portion 35 and is fed to the label attaching mechanism 20.

Further, based on the detection result of the third sensor 36, the position adjuster 115 generates a negative pressure in the air pressure generator 26 in accordance with the transmission timing of the defective label L′, thereby controlling the timing at which the suction portion 23 starts applying suction force to the defective label L′. Thus, the suction portion 23 applies suction force to the defective label L′ which is peeled from the conveying belt 31. The air pressure generator 26 may be controlled in cooperation with the suction controller 112.

As described above, when the defective label L′ is detected, the position adjuster 115 makes the label L′ to be positioned below the suction portion 23 and recovers the recovered defective label L′, by re-applying suction force to the recovered defective label L′ adjusting the suction position of the defective label L′ on the suction portion 23.

The defective label L′ which has been suctioned again to the suction surface 23a is detected by the second sensor 24, and when it is determined that it is at a normal position by the defective label sensor 113, the defective label L′ is applied to the object O as the label L under the control of the label attaching controller 114.

When the defective label sensor 113 judges that the defective label L′ is still defective, the position adjuster 115 performs the above-described operations again, so that the suction position may be readjusted, or the defective label L′ may be held on the conveying belt 31 as a reusable label L′. In the latter case, for example, it is preferable that the position adjuster 115 sets aside a region of a portion of the conveying belt 31 as a holding region, and controls a defective label L′ which is not reusable to be applied to or superposed on the holding region. Alternatively, the upper limit value of the number of attempts to be readjusted may be set in advance, and when the upper limit value is not reached, the defective label L′ may be held on the conveying belt 31 as a reusable label L′. Further, when the upper limit value is reached, the operator may be notified of the defective label L′ by e-mail transmission, LED lighting, buzzer sound, or the like.

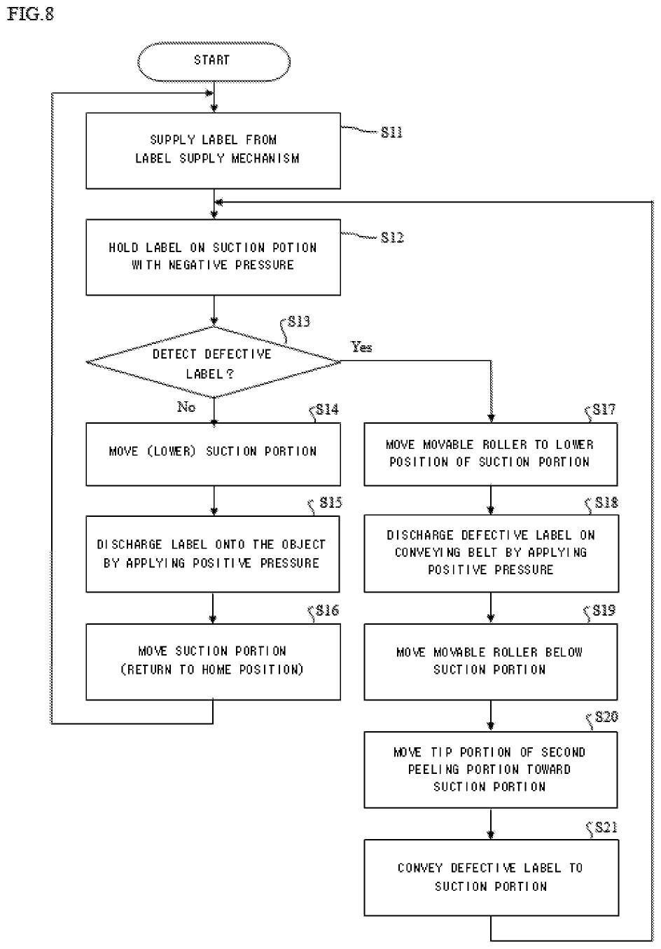

Next, the operation of the label supply apparatus 1 described above will be described with reference to FIG. 8. FIG. 8 is a flowchart illustrating an example of a label application process performed by the label supply apparatus 1. It should be noted that, at the start of this processing, the “suction portion 23” is located at the home position.

First, the supply controller 111 controls the sheet winding shaft 13 to supply the label L to the label attaching mechanism 20 from the label supply mechanism 10 (step S11).

The suction controller 112 applies a negative pressure to the suction portion 23 in accordance with the supply timing of the label L, thereby causing the label L supplied from the label attaching mechanism 20 to be suctioned and held in the suction portion 23 (step S12). Then, the defective label sensor 113 determines whether or not the defective label L′ is detected based on the sensing result of the second sensor 24 (step S13).

When it is determined in step S13 that the defective label L′ is not detected (step S13, No), the label attaching controller 114 moves (lowers) the suction portion 23 (step S14), and applies a positive pressure to the suction portion 23 to discharge the label L onto the object O (step S15). Then, the label attaching controller 114 turns off the air pressure in the suction portion 23, moves the suction portion 23 to the home position (step S16), and returns the process to step S11.

On the other hand, when the defective label L′ is detected in step S13 (step S13, Yes), the position adjuster 115 moves the movable roller 33 to be below the suction portion 23 to position the conveying belt 31 below the suction portion 23 (step S17). Then, the position adjuster 115 applies a positive pressure to the suction portion 23 to cause the label L to be ejected onto the conveying belt 31 (step S18).

Subsequently, the position adjuster 115 moves the movable roller 33 away from the suction portion 23 so as to retract the conveying belt 31 from a position below the suction portion 23 (step S19). Then, the position adjuster 115 rotates the second peeling portion 35 to move the tip portion 35a toward the suction portion 23 (step S20), and drives the driving roller 32 to carry the defective label L′ on the conveying belt 31 (step S21), and then returns to the step S12.

In step S12, the suction controller 112 (or position adjuster 115) applies negative pressure to the suction portion 23 in accordance with the supply timing of the defective label L′, thereby suctioning and holding the defective label L′ in the suction portion 23, and the process proceeds to step S13.

As described above, in the label supply apparatus 1, when the suction position of the label L in the suction portion 23 deviates from the area AL, the conveying belt 33 for recovering the label L (defective label L′) from the suction portion 23 is positioned below the suction portion 23, and the recovered defective label L′ is suctioned again onto the suction portion 23 to adjust the suction position. Thus, even when the label supply apparatus 1 detects a defective label L′, it can automatically recover the defective label L′ and reuse the recovered defective label L′, so that the label L can be attached without wasting the label L.

Further, the upper limit of the number of attempts to perform readjustment is set, and re-adjustment is performed a plurality of times, thereby making it easier to reuse the defective label L′. Further, even if the readjustment is repeated up to the maximum number of times, only the defective label L′ which is not likely to be suctioned at an appropriate position can be removed to the operator, thereby making it possible to make the operation not wasteful.

Further, according to the label supply apparatus 1, even in the case where labels L with serial numbers are attached to the label L, labels L can be attached to the object O in a sequential order without discarding the label L (defective label L′), so that the label L can be attached without skipping any number.

The above-described embodiment may be modified appropriately by changing the configuration or function of the label supply apparatus 1. Therefore, in the following description, several modifications according to the embodiments described above will be described as other embodiments. In the following description, points different from those described above are mainly described, and a detailed description thereof will not be repeated. Further, the modifications described below may be carried out individually or in combination.

[Modification 1]

In the embodiments described above, the operation of controlling the operation of the label supply apparatus 1 by the control unit 101 is described, but the present invention is not limited thereto, and each of the label supply mechanism 10, the label attaching mechanism 20, and the collection mechanism 30 may be configured to include a separate control unit that has a processor.

In this case, for example, the supply controller 111 described above may be implemented as a software configuration or a hardware configuration by a control unit included in the label supply mechanism 10. Further, the suction controller 112 and the label attaching controller 114 may be implemented as a software configuration or a hardware configuration by a control unit included in the label attaching mechanism 20. Further, the defective label sensor 113 and the position adjuster 115 may be realized as a software configuration or a hardware configuration by a control unit included in the collection mechanism 30. However, it is not limited to the above examples and the functional components realized by the respective mechanisms may have either a software configuration or a hardware configuration as appropriate.

In addition, when each of the label supply mechanism 10, the label attaching mechanism 20, and the collection mechanism 30 is provided individually with a computer configuration, each of these mechanisms may be defined as an independent device. In this case, the label supply apparatus may be a label application system implemented by cooperation of the label supply mechanism 10, the label attaching mechanism 20, and the collection mechanism 30. For example, when the label attaching mechanism 20 is a label supply apparatus, the collection mechanism 30 may be a label collection apparatus that can be mounted on a label supply apparatus.

In the case where the object O is conveyed by the transport device 2, the label supply device 1 or the label application system including the transport device 2 may be used. Further, when a printing apparatus for printing characters and images on the surface of the label L is included, the label supply apparatus 1 or the label application system including the printing apparatus may be used.

[Modification 2]

In the embodiment described above, when the defective label L′ is collected, a configuration is described in which the defective label L′ is moved by the movable roller 33 to locate the conveying belt 31 under the movement of the movable roller 33, but the mechanism related to the recovery of the defective label L′ is not limited thereto.

As an example, the collection mechanism 30 including the conveying belt 31, the driving roller 32, the movable roller 33, the tension roller 34, the second peeling portion 35, and the third sensor 36 shown in FIG. 7A, may be configured to be movable to be position below the suction portion 23. In this case, the movable roller 33 may be a fixed roller similar to the driving roller 32, and may be configured to move with the collection mechanism 30 as a whole.

As another example, the collection mechanism 30 including the conveying belt 31, the driving roller 32, the movable roller 33, the tension roller 34, the second peeling portion 35, and the third sensor 36 shown in FIG. 7C may be configured to be movable to a position below the suction portion 23. In this case, the movable roller 33 may be a fixed roller similar to the driving roller 32, and may be configured to move with the collection mechanism 30 as a whole. Further, the tension roller 34 may be omitted. Further, the second peeling portion 35 may be fixed in the state shown in FIG. 7C.

[Modification 3]

In the above embodiment, the suction portion 23 is moved toward the object O by moving the suction portion 23 toward the object O, but the configuration is not limited to this. For example, a configuration may be adopted where the object O is moved (raised) toward the suction portion 23 so that the suction portion 23 is relatively close to the object O.

[Modification 4]

In the above-described embodiment, the defective label L′ recovered from the suction portion 23 is immediately re-suctioned (reused) to the suction portion 23, but the timing for reuse is not limited to this.

For example, position adjuster 115 may be controlled to retrieve the defective label L′ onto the conveying belt 33 and hold the recovered defective label L′ side-by-side on the conveying belt 33. In this case, after the recovery of the defective label L′, the position adjuster 115 causes the label attaching mechanism to execute label attaching operation with the label L newly supplied from the label supply mechanism 10 by the supply controller 111 operation. Then, when the recovered defective label L′ reaches a predetermined number, for example, the position adjuster 115 suppresses the operation of the supply controller 111 and causes the label attaching mechanism 20 to perform the label attaching operation using the defective label L′ sequentially sent from the conveying belt 33.

Thus, in the label supply apparatus 1 according to the present modification, the recovered label L (defective label L′) can be reused at an arbitrary timing, so that the processing efficiency related to the label attaching of the label L can be improved.

Although the program executed by the label supply apparatus 1 is previously incorporated into the memory 104 included in the label supply apparatus 1 in advance, it is not limited thereto, and may be recorded on a computer-readable recording medium such as a CD-ROM, a flexible disk (FD), a CD-R, a digital versatile disk (DVD), or the like, by a file in an installable format or a file in an executable format. Further, the storage medium is not limited to a computer or a medium independent of an embedded system, but also includes a storage medium which is stored or temporarily stored by downloading a program transmitted by a LAN, the Internet, or the like.

Alternatively, the program executed by the label supply apparatus 1 may be stored on a computer connected to a network such as the Internet, and may be downloaded via a network via a network via a network. Also, a program executed by the label supply apparatus 1 may be provided or distributed via a network such as the Internet.

While the embodiments of the present invention have been described above, this embodiment has been presented by way of example and is not intended to limit the scope of the invention. The novel embodiments can be implemented in various other forms, and various omissions, substitutions and changes can be made without departing from the spirit and scope of the invention. The present embodiment and variations thereof are included in the scope and spirit of the invention, and are included in the appended claims and the equivalents thereof.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed:

1. A label supply apparatus, comprising
a suction portion having a suction surface on which a label with an adhesive is to be held;
sensors on the suction surface; and
a controller configured to determine whether the label is held on the suction surface at a proper position or an improper position based on sensing results from the sensors.

2. The label supply apparatus according to claim 1, wherein the controller determines that the label is held on the suction surface at the proper position when all the sensors detect the label and that the label is held on the suction surface at the improper position when all the sensors do not detect the label.

3. The label supply apparatus according to claim 1, further comprising:
an air pressure generator configured to generate negative or positive pressure at the suction surface,
wherein the controller controls the air pressure generator to generate the negative pressure at the suction surface when the label is to be held on the suction surface, and to generate the positive pressure at the suction surface when the label is to be attached to an object placed below the suction surface.

4. The label supply apparatus according to claim 1, further comprising:
a first conveying belt from the which the label is supplied to the suction portion; and
a second conveying belt onto which the label held on the suction surface at the improper position is supplied.

5. The label supply apparatus according to claim 4, wherein the first conveying belt is driven in a first direction to convey the label to a position below the suction portion and the second conveying belt is driven in a second direction opposite to the first direction to convey the label supplied to the second conveying belt to a position below the suction portion.

6. The label supply apparatus according to claim 5, wherein the second conveying belt is suspended around a movable roller and a driving roller, and the movable roller is moved to a first position when the label held on the suction surface at the improper position is supplied onto the second conveying belt and to a second position that is retracted away from the suction portion when the second conveying belt is driven in the second direction to convey the label to the position below the suction portion.

7. The label supply apparatus according to claim 6, further comprising:
a peeling portion configured to move with the movable roller and to also rotate about a rotational axis of the movable roller between a retracted position at which the label held on the suction surface at the improper position is supplied onto the second conveying belt and an extended position at which the label is peeled off from the second conveying belt and picked up by the suction surface.

8. The label supply apparatus according to claim 7, further comprising:
an air pressure generator configured to generate negative or positive pressure at the suction surface,
wherein the controller controls the air pressure generator to generate the positive pressure at the suction surface when the label held on the suction surface at the improper position is supplied onto the second conveying belt and the negative pressure at the suction surface when the label is picked up by the suction surface from the second conveying belt.

9. The label supply apparatus according to claim 8, further comprising:
a sensor positioned along the second conveying belt to detect the label conveyed by the second conveying belt.

10. The label supply apparatus according to claim 9, wherein the controller controls the air pressure generator to generate the positive pressure at the suction surface according to a timing at which the sensor detects the label conveyed by the second conveying belt.

11. A label supplying method, comprising
holding a label onto a suction surface;
sensing a position of the label on the suction surface;
determining whether the label is held on the suction surface at a proper position or an improper position based on the sensing; and
attaching the label onto an object if the label is held on the suction surface at the proper position.

12. The label supplying method according to claim 11, determining that the label is held on the suction surface at the proper position when all the sensors detect the label and that the label is held on the suction surface at the improper position when all the sensors do not detect the label.

13. The label supplying method according to claim 11, further comprising:
generating negative pressure at the suction surface when the label is held on the suction surface; and
generating positive pressure at the suction surface when the label is attached to the object.

14. The label supplying method according to claim 11, further comprising:
conveying the label on a first conveying belt to a position below the suction surface; and
supplying the label held on the suction surface at the improper position to a second conveying belt.

15. The label supplying method according to claim 14, further comprising:
driving the first conveying belt in a first direction to convey the label to a position below the suction surface; and
driving the second conveying belt in a second direction opposite to the first direction to convey the label supplied to the second conveying belt to a position below the suction surface.

16. The label supplying method according to claim 15, wherein the second conveying belt is suspended around a movable roller and a driving roller, and the movable roller is moved to a first position when the label held on the suction surface at the improper position is supplied onto the second conveying belt and to a second position that is retracted away from the suction portion when the second conveying belt is driven in the second direction to convey the label supplied to the second conveying belt to the position below the suction portion.

17. The label supplying method according to claim 16, further comprising:
rotating a peeling portion that moves with the movable roller about a rotational axis of the movable roller between a retracted position at which the label held on the suction surface at the improper position is supplied onto the second conveying belt and an extended position at which the label is peeled off from the second conveying belt and picked up by the suction surface.

18. The label supplying method according to claim 17, further comprising:
generating positive pressure at the suction surface when the label held on the suction surface at the improper position is supplied onto the second conveying belt, and negative pressure at the suction surface when the label is picked up by the suction surface from the second conveying belt.

19. The label supplying method according to claim 18, further comprising:
detecting the label conveyed by the second conveying belt.

20. The label supplying method according to claim 19, wherein the positive pressure is generated at the suction surface according to a timing at which the sensor detects the label conveyed by the second conveying belt.
